(19) United States
(12) Patent Application Publication
(10) Pub. No.: US 2005/0119124 A1
(43) Pub. Date: Jun. 2, 2005

(54) Phosphorus and potassium fertilizer for all forms of perennial trees, vines and annual crops

(76) Inventor: Alfred Alyeshmerni, San Diego, CA (US)

Correspondence Address: Alfre Alyeshmerni, P O Box 8283, Rancho Santa Fe, CA, 92067, US

(21) Appl. No.: 10/484,345

(22) PCT Filed: Jun. 13, 2000
(86) PCT No.: PCT/US00/16219

Related U.S. Application Data
(60) Provisional application No. 60/139,692, filed on Jun. 14, 1999.

(51) Int. Cl. A01N 25/00

(52) U.S. Cl. 504/116.1

(57) ABSTRACT

Energizing formulations of phosphorous and potassium fertilizer are disclosed that comprise maximally efficient phosphorous pentoxide and di-potassium monoxide combinations. Methods of manufacture and use for these compounds and formulations are also disclosed. The fertilizer formulations comprise both solid and liquid formulations having variable or fixed pH ranges that are acceptable for aerial, foliar, and soil applications, and suitable for all forms of perennial trees, vines and annual crops. The formulations further possess the ability to control pathogenic soil microorganisms through the use of, for example, formulations comprising combinations of monopotassium phosphite, monopotassium phosphate. monopotassium nitrite, monopotassium nitrate, monopotassium sulfite and monopotassium sulfate.

### RELATED CASES

This application claims priority under 35 USC 371 to PCT US00/16219 filed Jun. 13, 2000 which is hereby incorporated by reference which claims priority to U.S. Provisional Application No. 60/139,692 filed Jun. 14, 1999.

### FIELD OF THE INVENTION

This invention relates to the field of liquid and solid fertilizer formulations and to methods of delivery to target plants.

### BACKGROUND OF THE INVENTION

Plants, like animals, require sources of nitrogen (N), phosphorous (P), potassium (K) and, to a lesser degree, a host of other elements. Commercial grade fertilizers are typically specified in terms of the big three: N, P and K. Nitrogen is required for protein biosynthesis, nucleic acid metabolism and chlorophyll (the green pigment that facilitates photosynthesis in plants). Adequate supplies of nitrogen are manifest as a deep green color; deficiencies are manifest by spotting, yellowing leaves, and wrinkling. Phosphorous and potassium form the basis for the invention.

Phosphorous is important for its widely understood role in energy metabolism and nucleic acid synthesis. In addition, phosphorous has been implicated in disease resistance, and in the promotion of budding and blooming. Deficiencies of phosphorous are manifest by stunted growth, and by a reddening of stems and leaves.

Potassium, otherwise known as “potash,” has been implicated in disease resistance, oil metabolism, and acclimation to weather change. It is thought to exert a strong, positive effect on root growth and proliferation. Potassium is abundant in the soil of the western United States and hence is frequently deleted from many commercial fertilizer formulations offered thereabouts. Potassium deficiencies are usually manifest as browning edges on leaves and mottled yellow or pale green mature leaves. As with phosphorous deficiencies, older leaves are usually affected first.

In nature, plants are able to extract these nutrients from the soil and transport them to other plant tissues through the use of a specialized vasculature and structure, namely xylem and phloem. These tissues provide for the bidirectional transport of different nutrients to feed and supply all the tissues of the plant. At the soil end of the plant are roots, which are specialized to absorb soil nutrients. At the other end of the plant are leaves, where photosynthesis (site of absorption and conversion of CO₂ to sugar) and transpiration (H₂O loss which helps pull nutrients up from the soil) occur. There is a mutual, bidirectional flow of products between these endpoints. At the root terminus, nutrients are gradually exhausted from the soil and require replenishment—especially for cultivated, high-yield crops.

Whereas nature would gradually replenish exhausted supplies or outright kill plants that are not properly adapted to a given soil condition, exogenously administered fertilizers allow plants that would otherwise perish or languish to thrive.

Fertilizers have a long-standing history and tradition that is ever-evolving in parallel with our increasing understanding of plant metabolism and biochemistry. The agricultural industry is constantly in pursuit of better fertilizers—fertilizers that have higher effect per cost, are more safe, and/or more convenient.

Certain nomenclature is standard in the fertilizer industry. As stated, fertilizer “formulations” are typically described in terms of NPK content or “grade”. This denotes not only the relative amount of the three primary nutrient ingredients, but also the total amount in percent weight. Each component is typically described in oxide form. For example, phosphorous is typically denoted as P₂0₅ and potassium as K₂O. A 10-10-10 fertilizer formulation, for example, denotes a 10% weight percentage of each of these constituent oxides or their metabolic equivalents within a given fertilizer.

The term “analysis” is also used to denote the relative concentration of plant nutrients, with a “high” analysis indicating high amounts of constituents within the grade formulation.

By “high” analysis is meant, preferably, formulations that include at least a 29% weight percentage of the phosphorous component or at least a 26% weight percentage of the potassium component, more preferably a formulation of at least 0-29-26, more preferably, at least 0-30-26, and most preferably at least 0-35-27.

Another term of art is “available phosphoric acid” (APA) which is the phosphorous available to plants as measured by an empirical solubility test known to those skilled in the art.

A “straight” fertilizer is one that usually contains only one nutrient and is applied to the soil uncombined with other materials. An example is a 0-0-40 formulation of KOH, which is a concentrated base form of potassium. This contrasts with a “mixed” or “compound” fertilizer, which is one containing two or more nutrients, e.g., the 10-10-10 formulation described above.

The term “complex” fertilizer denotes a multinutrient fertilizer, usually made by a process based, at least in part, by the neutralization of an acid or other chemical interaction of ingredients. The terms “mixed”, “compound”, and “complex” are frequently used interchangeably in the industry.

The term “materials” denotes nutrient carriers used in making mixed fertilizers.

The term “direct application” is the application to the soil of a primary fertilizer, without first combining it with other fertilizer materials.

“Conditioning” is the treatment of fertilizer to reduce hygroscopicity and precipitation while in storage.

A “supplemental” fertilizer is one that is used in conjunction with other fertilizers or natural conditions for maximum desired effect.

Fertilizer formulations may take either solid, liquid, or suspension form. Solids are usually supplied either straight or blended granular. Bulk blenders exist which can mix custom grades of solid fertilizers to a grower's specifications or to recommendations based upon soil analysis. Solid forms are desirable in that they are concentrated.

Liquid and suspension forms may also be either straight or mixed and are generally more reactive and unstable, hence requiring specialized shipping and handling that translates to increased cost.

Phosphoric acid (H₃PO₄) and salts thereof represent an important constituent of commercial fertilizers. Potassium phosphate, a salt of phosphoric acid, has special appeal because of its potential for high analysis in formulations, its freedom from chloride (relatively toxic to plants), and its high solubility. Consequently, it has been the subject of intensive searches for methods of economical production.

A more reactive molecular species of phosphorous, phosphorous acid (H₃PO₃), and its phosphite (or phosphonate) salts, has recently been demonstrated to be of use due to its superior water solubility, foliar absorption, and fungicidal properties. These properties are discussed in U.S. Pat. No. 4,119,724 issued to Thizy, and U.S. Pat. No. 5,800,837 issued to Taylor. While some studies suggest that phosphite use as a plant growth stimulator is unclear, or even inadvisable (see Forster et al. (1998) Plant Disease, Vol. 82, No. 10, pp. 1165-1170), other studies maintain that the use of phosphite is at the least very beneficial as a conjunctive supplement. See U.S. Pat. No. 5,830,255.

That phosphite slowly converts to phosphate in the presence of oxygen all the more supports this position. Phosphite can thus be viewed as a metabolic time-release growth stimulant while in or near a plant. For example, the plant metabolizable form of phosphorous is (H₂PO₄), which is a decomposition product of phosphate. Consistent with this are reports in the literature that initial annual crop response to phosphites is not as great as that of succeeding crops. Interestingly, P₂0₅ combined with K₂O has the ability to form either phosphorous acid or phosphoric acid, depending on the precise manufacturing conditions employed.

The heretofore appreciated merits of phosphate and phosphite-based fertilizers and combinations thereof may generally be found in U.S. Pat. Nos. 5,830,255 and 5,830,200 issued to Lovatt, U.S. Pat. No. 5,800,837 issued to Taylor, and U.S. Pat. Nos. 5,707,418 and 5,865,870 issued to Hsu.

The Lovatt patents disclose and claim, respectively, buffered phosphorous-containing fertilizers and buffered phosphorous-containing fertilizers to which have been added specific organic acid stabilizers. Those patents teach, at most, 0-30-30 formulations for use after 40-600-fold aqueous dilution.

U.S. Pat. No. 5,800,837 teaches the combined use of potassium phosphate and potassium phosphite in liquid stock 0-22-20 and 0-18-20 formulations.

The Hsu patents similarly disclose and claim phosphite and phosphate fertilizer combinations. Specifically, the Hsu patents teach 0-40-0, 0-15-14, 0-27-25, 0-28-25, 4-25-15, and 0-12-11 formulations.

None of the above patents, nor anything in the art of which the Applicant is aware, teach higher analysis fertilizer grades of combined phosphates and phosphites. Furthermore, no where in the art is there an attempt to balance or modify pK or pH prior to dilution and supply to plants, nor has there been an attempt to balance different potassium phosphite and/or phosphate species within a given fertilizer formulation, taking account of the polyprotic nature of phosphoric acid, phosphorous acid, and derivatives thereof. Moreover, the art has not heretofore identified gaseous requirements and give-off from the various phosphate and phosphite metabolisms as a means of potentially harnessing and optimizing these fertilizers' effectiveness, and alternative prowess as fungicides.

Such products would, in addition to having the merits espoused in the above patents, be extremely economical, efficient, and convenient for commercial and residential growers alike, as well as for those in academia and governmental testing concerns. This owes to the noncorrosive nature of the formulation and to a relatively high solubility that render administration and handling easier and hence more economical. Furthermore, equipment in contact with such formulations lasts longer, e.g., conduit pipes and spraying apparatuses because they do not corrode, clog, or otherwise degrade. Furthermore, a solution that requires no extraneous stabilizers or buffering components would likewise keep manufacturing costs down and retail zeal up. Such concentrated supplies of high analysis PK fertilizers would also be readily amenable and adaptable to various means of crop administration known in the art. Such formulations are described herein, as are general and specific means for manufacture and supply to plants, both as fertilizers and as microbial pesticides.

### SUMMARY OF THE INVENTION

It is an object of the invention to supply high grade, high analysis, optionally unbuffered, phosphorus and potassium fertilizer stocks that have not been heretofore available commercially, e.g., among the list provided in FIG. 3. In various embodiments, the stocks are balanced in at least one of the following senses: phosphorous and potassium content, pH, or gas evolution. In other embodiments there is a deliberate imbalance of these features.

It is a further object of the invention to indicate an economical manufacturing means by which the above may be achieved. This method includes reacting a phosphorous-containing acid with a base such as KOH, and harnessing the exothermic heat generated to effectively evaporate water, thereby leaving a relatively pure, concentrated fertilizer as described generally herein.

It is another object of the invention to supply high solubility fertilizer(s) in liquid or solid form for convenient application to plants, whether by foliar, root, or intravenous administration. In various embodiments, application is accomplished by the use of suitable and specialized equipment that is designed for the particular type of administration to be performed.

It is a further object of the invention to supply a fertilizer that is relatively safe, easy, and inexpensive to produce, package, and handle.

It is a further object of the invention that the above formulations be offered as kits having acid and base stocks for suitable pH adjustment and customized application to various soils and plants.

Another object is the supply of a multi-dimensional product that is capable of supplying both growth and disease-resistance to plants. Thus, in one preferred aspect, the formulation can be made to introduce bactericides, fungicides, antivirals, and antibiotics. Another preferred method of enhancing the product's bactericidal properties is to produce the formulation at a pH of 1.5. Preferably, the formulation at pH 1.5 is the 0-59-39 formulation.

In most preferred aspects, the formulation is a solid at 2° centigrade. For example, the formulation 0-59-39 is solid at 2° C.

In another object of the invention, the potassium source used is potassium nitrite.

Yet a further object is the supply to the soil a formulation that kills fungus and microbes in a specific or general manner, but which can also be absorbed by the plant to effect a desirable result. In various embodiments, the noted fungicidal or microbicidal activity correlates with or results from the gaseous give-off in the soil that occurs upon formulation decomposition or equilibration.

It is another object to use a formulation with a slow-acting activity whose bi-products with time are readily metabolized by the plant, e.g., phosphites, for a “time-release” aspect.

It is a further object of the invention to implement the novel formulations described herein in terms of manufacture and deployment methods, i.e., specific and general administration to plants. In one preferred aspect, the novel formulation is spray-dried after the original ingredients are reacted. In another preferred aspect, the formulation can be administered in drip irrigation. Preferably, the formulation administered is the 0-59-39 formulation.

It is a further object of the invention to provide methods of treating and preventing disease in plants using the formulations of the present invention. It has been found, surprisingly, that the formulations of the invention have the ability to flow through the system of the plant, carrying other components through the plants such as antibiotics, antifungals, and antivirals. It is yet another object of the invention to treat Pierce disease using the novel formulations of the invention.

It is a further object of the invention to provide formulations comprising various combinations of monopotassium phosphite, monopotassium nitrite, and monopotassium sulfite with monopotassium phosphate, monopotassium nitrate, and monopotassium sulfate. Thus, for example, the invention contemplates a fertilizer formulation comprising monopotassium phosphite, monopotassium phosphate and monopotassium nitrite and/or monopotassium sulfite. The addition of monopotassium nitrite, for example, should provide additional bactericidal properties. The invention contemplates the use of such combination fertilizer formulations for the various uses described herein, such as for the treatment and prevention of plant disease, and for the fertilizing of plants to enhance productivity and growth.

### DESCRIPTION OF THE DRAWINGS

FIG. 1 illustrates various phosphorous-containing acids that can be combined with potassium and used in novel formulations of the invention.

FIG. 2 illustrates the relative molar amounts of phosphorous, potassium, hydrogen, and oxygen required for formation and/or decomposition of the various potassium phosphate and phosphite species.

FIG. 3 illustrates a chemical analysis of various commercially available fertilizers.

FIG. 4 is a bar graph depicting the results on celery weight after treatment with the 0-35-27 formulation (“PhosGerize”) compared to control (GSP:CHECK) to other commercial products.

### DETAILED DESCRIPTION OF PREFERRED EMBODIMENTS

Definitions

The following term definitions are intended to supplement those already given in the background section, above.

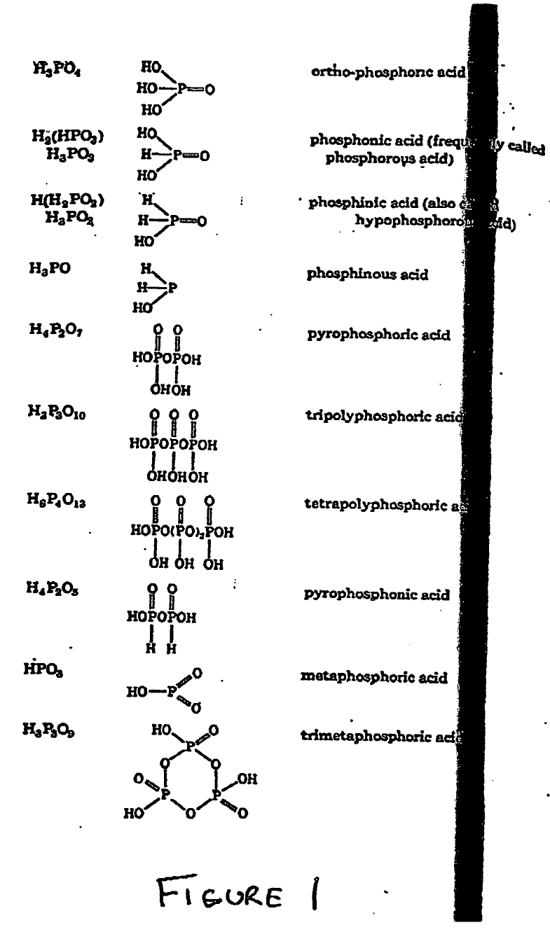

As used herein, the term “phosphorous-containing” is meant to embrace phosphorous acids and oxides including but not limited to those shown in FIG. 1.

The terms “comprising between about” and “comprising about between” mean including but not limited to. In this context, use of the term “about” is used to denote flexibility that is consistent with other definitional occurrences of that term in this application. The term should additionally be construed as not so flexible as to read on any prior art formulations that may exist.

The terms “consisting essentially of between about” and consisting essentially of about between” mean imparting the essential ingredients that are useful outside of the presence of other additional ingredients that may or may not be present in the formulation. The term “about” has the same meaning here as for the above.

The terms “mono-” “di-”, and “tri-” potassium denote the number of substitutions that a phosphorous-acid, as described above, may form or that may be present in any particular formulation, combination of formulations, or mixture contemplated by this invention.

The term “molar ratio” is used in its classical sense and denotes the relative molecular weights of the various fertilizer components. In the spirit of the flexibility noted above concerning use of the term “about”, it is understood that various hydrated species of the individual components and their products may also exist.

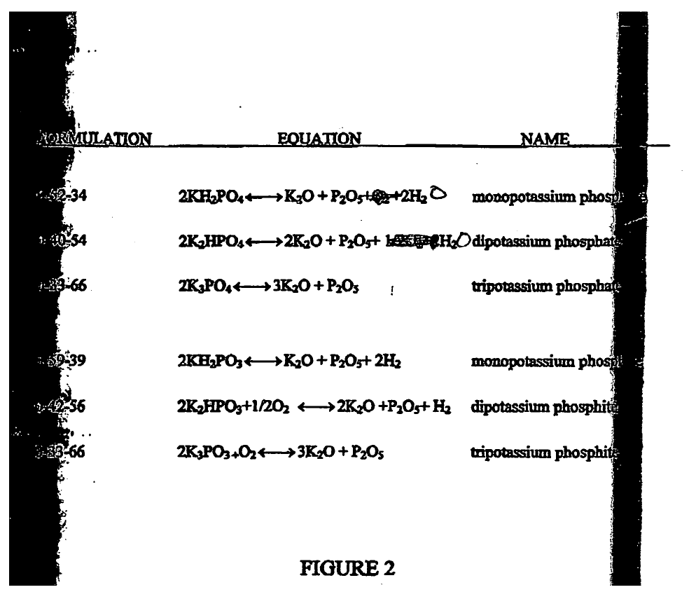

By the term “mixture” is meant a combination of reactant-components or fertilizer formulations. For example, the noted 0-59-39 formulations may be combined in different proportions with other formulations selected from FIG. 2. The mixture may be dry or aqueous, homogenous or nonhomogenous. Preferably, prior to or during administration, a homogenization takes place.

By “unbuffered” is meant that no extrinsic buffering components or agents are added or present, e.g., organic acids. The term “buffer” otherwise takes on its usual, classical understanding.

By “time-release” is meant the gradual ability of a phosphorous-containing acid or salt thereof to oxidize into phosphate and thereby be metabolized or otherwise used more efficiently by a plant. It therefore denotes a relative reservoir of more or less efficient fertilizer than can naturally or artificially be induced to adopt a more efficient or more potent form when supplied in or to a plant.

By “dessicated stock” is meant a dry composition or formulation of fertilizer that can be degassed, e.g., vacuum-sealed and/or to which a chemical dessicant has been added that otherwise does not interfere with the chemical or functional integrity of the fertilizer. The term “stock” is merely used to denote the potential for further dilution, either, in solid form via the addition of other solid ingredients, or else in liquid form via the addition of water or other aqueous solution.

The term “dilution”, unless otherwise indicated, is meant to embrace both dry and wet lessenings in concentration.

The term “substantially nonreactive” means not reacting in appreciable amount so as to negatively affect the potency or effect of a given fertilizer formulation upon administration to a plant.

The term “irrigational delivery system” is meant to embrace both hand-held portable devices or stationary complexes that deliver water to the soil surrounding a plant, or to a hydroponic culture. Stationary complexes may be a standard PVC or rubber hose system with an appropriately mounted head at the delivery end point, e.g., a drip or a spinning/rotating head for suitable water dispersal at the site of application.

### 1. High Analysis Potassium Phosphite and Phosphate Stocks

In a preferred embodiment, the formulation is unbuffered, solid or granular, and comprised of potassium monobasic phosphite containing about 59% phosphorous and 39% potash. The product is produced by completely reacting equimolar amounts of phosphorous and potassium oxides or else separating desired monosubstituted product from a mixture of heterogeneously substituted produced. In another preferred embodiment, the formulation is unbuffered, solid or granular and comprised of potassium monobasic phosphite containing about 35% phosphorous and 27% potash. The stock may contain some di and tri-substituted potassium phosphite species.

In preferred embodiments, the stock is diluted 200-2000 fold for use, preferably closer to 2000 to permit the greatest economical use. In some embodiments, stock components are supplied alone and work independently of any other supplied reagents, i.e., the formulation “consists essentially of” potassium phosphites and/or phosphates. In other embodiments, it is a supplemental fertilizer to be simultaneously or sequentially supplied in conjunction with other growth promoting substances, whether organic or inorganic. In such embodiments, the formulations are said to “comprise” potassium phosphites and/or phosphates.

In other embodiments, the stock is supplied as a relatively pure dibasic or tribasic potassium phosphate or phosphite composition having formular analyses as depicted in FIG. 2. Preferred are the phosphite formulations of FIG. 2, e.g., 0-59-39, 0-42-56, 0-33-66, and 0-35-27 and mixtures thereof and ranges there between and beyond in phosphorous and potassium content. Phosphates may also be included along with phosphites in particular embodiments. The specific formular species of 0-59-39, 0-42-56, and 0-33-66 depicted in FIG. 2, for example, are formed respectively from 1:1, 2:1, and of 3:1.

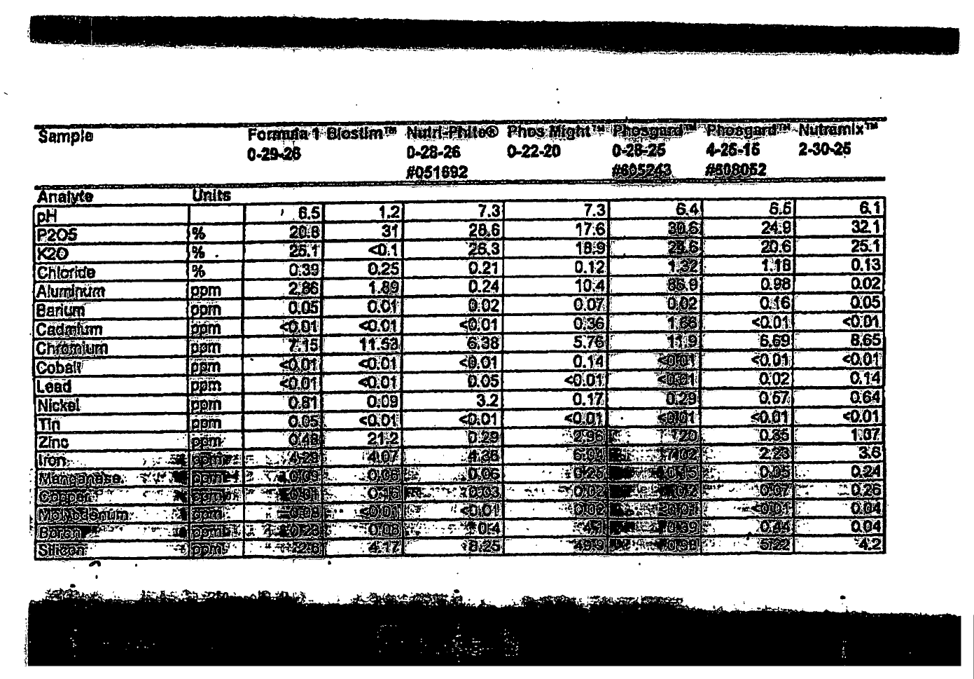

Mixtures of the above species in a solid or liquid stock are also contemplated. Thus, a mixed solid stock may include between about 33% and 59% phosphorous and between about 39% and 66% potassium. In particularly preferred embodiments, the ratios and/or amounts of phosphorus and potassium are different than existing commercially available products such as described in FIG. 3.

Pure phosphate stocks and mixtures of the possible mono, di, and tri substituted species are also contemplated. An essentially pure mono form comprises about a 0-52-34 formulation; an essentially pure dibasic form comprises about a 0-40-54 formulation; and a pure tribasic includes about a 0-33-66 formulation. Mixtures of these forms, as for the phosphites above, are also contemplated. The range thus falls between about 33 and 52% phosphorous (P₂0₅), and about 34 to 66% potassium (K₂0). For each of the phosphites and phosphates, it is desirable that whatever the phosphite or phosphate weight percentage, a reciprocal percentage of potassium (with allowance for evolved or required gases) be present so as to balance the equation for decomposition of the fertilizer. See FIG. 2 and Example 1, below.

In some embodiments, all of the potassium and phosphite ions in a stock are preferably complexed to one another or capable of complexing to one another. In still other embodiments, there is an excess of one species of ion relative to the other. This has the effect of providing differential pH upon solubilization in water.

In certain preferred embodiments, formulations comprise or consist essentially of phosphorous-containing acids or salts thereof that result in no net evolution of gas, e.g., hydrogen, upon decomposition. Such formulations may consist of or comprise, for example, monopotassium phosphate and tripotassium phosphite, which combination provides for an intermediate, gentle pH when in solution, and otherwise supplies a balanced amount of phosphorous and potassium.

As used herein, the term “about” is meant to approximate the ideal percentage amounts of phosphorous and potassium available in the various phosphite and phosphate formulations of the invention. The term may also allow for the presence of molecular water or other impurities that may separate the above formulations from their theoretical maximums.

The fertilizer compounds may be supplied in vacuum or sealed, dessicated container designed to slow the oxidation of phosphite to phosphate. The container is preferably non-reactive with the formulation to preserve purity and desired activity.

### 2. Methods of Manufacturing Stock

The 0-59-39, 0-42-56, and 0-33-66 formulations, mixtures thereof, and other formulations described above may either be accomplished by a manufacturing method which permits the simultaneous synthesis of each of the species within one reaction vessel, or else a mixture of pure species, each of which is isolated from separate reactions or from one continuous reaction whose products are capable of separation and purification by methods known in the art.

As discussed, stock formulations in certain aspects and embodiments are intended to maximize potassium phosphite and phosphate conversion from starting components. In other embodiments, there will either be an excess of unreacted potassium relative to phosphorous-containing acid, or else an amount of potassium which is limiting and insufficient to permit substitution into every molecule of phosphorous-containing acid that is present.

Manufacturing methods are contemplated which result in the above formulations and range of formulations, and dilutions thereof that substantially maintain the ratio or average ratio of phosphorus and potassium products.

Representative reactions contemplated within the scope of the invention include reactions such as disclosed below for phosphite synthesis:
nP₂O₅+mK₂O←- - - →KxHyPO₃ {Solid reaction} (1)
nH₃PO₃+mKOH - - - →KxHyPO₃+H₂O {Liquid reaction} (2)
The variables n and m in the equation denote the possibility for different molar amounts of the respective reactants depending on the specific desired potassium phosphite product or mixture of products. The variables x and y denote the level of potassium substitution of the product. In certain preferred embodiments, each of X and Y may assume a value of from 0-3. In other preferred embodiments, however, x will assume a value of from 1 to 3, and y will assume a value of from 1 to 2, indicating the absence of pure acid. The same general reaction schemes may be used to produce phosphates. At the present time, the Applicant prefers method two preparation, coupled with dehydration or evaporation to yield the solid, concentrated, high analysis stock formulations described. This evaporation may make use of extraneous and/or internal evaporative means relative to the exothermic acid-base reaction. In one preferred method, the product is spray-dried after the original ingredients are reacted.

For manufacture of a product using potassium nitrite as a starting material, a representative reaction, for a 1-59-39 formulation, is as follows:

$${K}_{2} {H}_{4} {P}_{2} {0}_{6} and {KN 0}_{2} {\to }^{metabolizes} {P}_{2} {0}_{5} and 2 {K}_{2} 0 + {HNO}_{3} + 3 / 2 {H}_{2}$$

Also encompassed within the scope of the present invention is a potassium sulfite product, a representative reaction is as follows:

$$2 {KH}_{2} {P0}_{3} + 2 {KHS0}_{3} {\to }^{metabolizes} 2 {K}_{2} 0 + {P}_{2} {0}_{5} + {H}_{2} {S0}_{4} + 2 {H}_{2} {H}_{2} {S0}_{3} + KOH \to {KHS0}_{3} + {H}_{2} O$$

Those of ordinary skill in the art understand that the molar amounts of the respective reactants may vary depending on the specific desired potassium nitrite or potassium sulfite product or mixture of products.

Also contemplated are combinations of monopotassium phosphite, monopotassium nitrite and monopotassium sulfite with monopotassium phosphate, monopotassium nitrate, and monopotassium sulfate.

Understood by those of skill in the art is that the general equations above are not balanced or complete and that various gases may also be present or necessary, depending on the particular desired product and plant results. Further understood is that temperature may be modulated to vary reaction success, specific product production, and relative direction and completion of the various reactions possible and described by the general equation schemes above. These parameters are intentionally omitted to depict the general nature of the reactions and their potential breadth and variability. Other components such as catalysts now known or later developed are also contemplated within the scope of the invention.

In preferred reactions, the exothermic heat generated from the acid-base reaction is harnessed to provide evaporative energy necessary to concentrate the fertilizers and render them substantially devoid of molecular water. This may be achieved in a variety of ways, but essentially involves adding the two components together in desired amounts to achieve the desired results. To avoid explosive volatility, one component is preferably gradually mixed in with the other in desired stoichiometic ratio such that sufficient heat is generated to evaporate any water that may be formed or present. Preferably, to avoid conventional acid splattering, the base is added slowly to the acid. In preferred embodiments, the concentrated acid may be in flake form, e.g., a 0-85-0 straight formulation, to which is then slowly added the base, e.g., a 0-0-40 formulation (concentrated liquid) or 0-0-80 formulation (granular) of KOH. A controlled or modulatable humidity may also be of value to the efficiency of the process, especially in solid-solid mixings. Thus, a system during such mixing is preferably of a higher relative humidity during the early stages of the reaction. One of skill will further appreciate that the relative mixing speed of the components may likewise be used to advantage.

In preferred embodiments, the pH is controlled or otherwise maintained so as to favor one potassium substituted species over another. For example, lower pHs favor monosubstitutions. Preferably, the pH range is to be maintained at approximately 3.5-4.5, and more preferably closer to 3.5 for mono-substituted products. If increased substitutions are preferred, one can accordingly increase pH. In one preferred aspect, the pH is about 1.5 for the 0-59-39 formulation, providing additional bactericidal properties.

In other embodiments, the hygroscopic nature of the reactants is overcome by mixing liquid spray mists of the reactants over a collection surface or vessel. Preferably such surface has a large surface area to achieve maximum efficiency of the reaction—that is, to facilitate water evaporation or distillation of water and avoid the otherwise hygroscopic properties of reactants. Those of skill in the chemical engineering arts will appreciate how this is to be done, and that such can be done without undue experimentation.

Those of skill will also appreciate that the percentages and formulations described above need not be exact and that the general principle may be applied to a wide range of formulations, dilutions thereof, and different acid and base strengths to render various concentrated solid fertilizers. One of skill will also appreciate that the process can be terminated at any time prior to complete evaporation of water so as to permit a concentrated liquid fertilizer as opposed to a strictly or substantially solid one.

Because substantial heat may occur, a suitable vessel or container should be used that does not react, decompose, or melt during the process, e.g., stainless steel or glass.

Those of skill in the industrial chemical arts know that the heat generated can be controlled by various convection means, e.g., a vacuum exhaust or fume hood. However, because temperature and pressure are related by the formula PV=nRT, raising the temperature, e.g., from an exothermic reaction, also raises the pressure such that a force is produced when in a closed system. Such force may be harnessed to extrude gaseous water vapor generated from the acid-base reactions described through a suitably oriented valve or exhaust-type system that may or may not be further assisted by an electronic vacuum means.

Furthermore, those of skill also know that the reaction can also be controlled by the use of a cooling means. Understood is that such means, as well as the convection means described in the previous paragraph should not be so great as to negate the desired evaporation of water from the exothermic system. Accordingly, sufficient heat is maintained as to maximally eliminate water, thereby leaving the concentrated fertilizer formulation. Understood also is that the cooling means and/or pressure means should be controlled so as not to permit water condensation back into the solid fertilizer upon overall cooling of the system when a substantially solid or dry product is desired.

Also apparent to one of skill is that various potassium phosphite products may also be produced by the equations as written but that the relative production or presence of these may be controlled or minimized using conventional methods in the art. Certain aspects and embodiments of the invention insist upon absolute purity of phosphites over phosphates and certain potassium bearing subspecies; others do not. In certain preferred embodiments, the predominant and substantially pure and active product is potassium phosphite. In others, the predominant species may be phosphates.

In certain other applications, combinations of potassium phosphites and phosphates may be desirable, such as when optimizing microbicidal activity. Thus, within the scope of the invention, phosphates may either appear as an undesirable impurity, an intended adjunct, or a primary species of and for the formulation.

Additionally contemplated for the invention is that micronutrient compounds such as copper, zinc, boron, magnesium, iron, calcium, sulfur, manganese, and molybdenum can supplement the above formulations, where permitted, and within respective solubility limits. Those of skill will know how to seek and measure particular plant deficiencies and formulate and administer the corresponding deficient compounds and metabolites using, at most, routine and modest experimentation. It is understood that a range of concentrations and conditions may be suitable to thwart malnutrition or symptomology.

It is furthermore understood that formulation syntheses that use strong acids and strong bases are exercised with caution and appropriate measures taken so as to avoid explosion, volatility, and otherwise risk of harm to those preparing and/or administering the formulations.

During or in the process of syntheses, those of skill appreciate that crystalline forms of phosphite and phosphate salts may be selectively precipitated from solution and conveniently separated and purified from aqueous components by conventional filtration, washing, and drying techniques. Those of skill also appreciate that drying or evaporation is generally appropriate to render an otherwise non-conforming stock dilution suitably concentrated within the scope of this invention.

### 3. Methods of Administration to Plants

Another aspect of the invention includes administration techniques of the formulations disclosed herein to their plant targets. Formulations described herein benefit most plants.

In preferred embodiments, administration is by direct application of spray or paint to leaf foliage. Another preferred embodiment is indirect foliar application by aerial spray or release, e.g., by plane. Yet other preferred embodiments include direct or indirect application to soil for absorption by roots, and vascular injection such as by syringe or other suitable applicator. Each technique has its own merits and unique indications, as will be readily understood by those of skill in the art.

A 200-2000-fold dilution of the stock is appropriate and effective, depending on various precise and imprecise factors known to those of skill in the art. Such factors include the plant or crop species to which the compound is to be administered, and the particular health and nutritional state of that plant or crop. Further related variables include soil pH, nutrient, and/or salt content. Additionally, and from a pesticidal perspective, various dilution strengths and potassium substitutions within the formulation boundaries described herein may be more or less appropriate and suitable.

One of skill further understands that certain application and administration routes are more wasteful than others. Thus, a technique such as injection is more resourceful and economical than spray or root delivery.

Still there may be applications where soil use is most desirable, such as for pesticidal applications where there are undesirable, plant-pathogenic microorganisms in the soil which are sensitive to, and capable of control by, the potassium phosphates and phosphites described herein. Alternatively, an irrigation system may be more practical for large crops and orchards, in which case formulation may be fed into the system near to the water source and delivered to the remote end points, i.e., drips or sprayers that feed the individual trees or plants, or groups thereof.

In preferred aspects and embodiments, effective aqueous dilutions of the stocks described are first made and then administered, either by hand or via an irrigational delivery system. The former may be accomplished by use of a pressurized or pressurizable drum or container that can uniformly or otherwise distribute the aqueous dilution about the base or foliage of a plant.

An irrigational delivery system as contemplated for such use is customized to meet the particular needs of the plant or crop to which it is to be delivered. For example, those of skill in the art appreciate that root systems vary widely from relatively shallow and disperse radial types such as characteristic of avocados, to more concentrated and deeper root systems such as for citrus. The latter are more effectively and economically accessed by a drip or feed system. For avocados, spinning or radial spray systems are widely considered most appropriate for uniformly distributing water and dissolved solutes, if any, to the plant's roots.

In a particularly preferred embodiment, the phosphite and phosphate formulations disclosed herein are readily dissolved in reservoirs connected to irrigation delivery systems. When the water source is turned on, the solid formulation in communication with the system readily dissolves and is freely administered to the soil at system endpoint(s), whether by spray or by drip. Those of skill in the art can calculate the needs of an orchard or crop that is on such a delivery system, measure out sufficient quantities of the concentrates described herein, and rapidly and efficiently administer them through a single point or points of origin in the irrigational delivery system. The ready solubility of the formulations permits their fast dissolution and efficient delivery. Multiple repeated applications may be performed in succession where solid reservoirs or single applications are insufficient or limiting in capacity.

Alternatively, and where reservoir size and/or crop size are not limiting, controlled continuous delivery is also contemplated, e.g., by slow injection or dispersion from a regulating device or source connected to a suitable reservoir or container for receiving and distributing the solid and liquid formulations described herein.

In particularly preferred applications, the endpoint is a device that can distribute the diluted formulation intravascularly by injection. In this way, a monitored, controlled drip such as used in hospital IV feed scenarios is contemplated. In less elaborate injection embodiments, a stake, nail, drilled hole, etc. is bored into a plant trunk or branch, and a liquid formulation as described deposited therein. The hole is preferably tangential to the radial diameter of the tree or shrub so as to maximize communication with and uptake by the vasculature of the plant, which typically resides in the radial periphery. At the present time, injectible formats contemplate either branch or trunk sections of a tree or plant, with the branch administration being preserved. In the event of an undesirable reaction, the branch may be conveniently eliminated without further appreciable concern to the balance of the tree or plant.

The injection technique may include the use of a plastic water or squirt bottle filled with an appropriate formulation dilution, or else a syringe in sealed or substantially sealed, or sealable communication with the hole entrance such that a closed volume system is created for the pressurized administration of a fertilizer solution. The hole proportions, geometry, and orientation depend on the size, shape, and health of the plant. Moreover, the length or depth of the hole should preferably not be so deep as to penetrate the opposing exterior of a stalk or branch so as to waste injected fertilizer.

At present, only IV injection of avocado trees has been attempted, and only with highly soluble phosphite solutions of the type described. This does not, however, preclude IV administration into other plants and/or different fertilizer formulations. Accordingly, flexibility is contemplated within the scope and spirit of the invention.

In preferred embodiments, the administration is by direct or indirect application of the stock solutions above that have been diluted 200-2000-fold, and which assume a working pH of between about 4 and 8, preferably between 5 and 7, and more preferably about 6-7, or neutral. While the applicant has found that the most concentrated formulations have a pH of about 1-5 and are tolerated by the plant, such use is acceptable but generally impractical as it is opposed to the true advantage of the invention which is a conserved and economical dilution that approaches neutrality. Nevertheless, one of skill is aware that foliage versus roots versus injection have different pH-dependent or pH-preferred responses that may be calculated without undue experimentation for any given plant species. The Applicant notes that the potassium and phosphorous-containing compounds described herein naturally have a suitable pH value across a wide range of dilutions, especially using potassium salts of the types described.

pH adjustment may be achieved conveniently in the stock itself by supplying or reacting a molar ratio of potassium to phosphorous that exceeds 3:1 or a molar ratio that is less that 1:1. Such can also constitute solid stock formulations of fertilizer. For example, a 0-85-15 formulation can be made in which phosphorous acid is reacted with submolar amounts of potassium hydroxide to yield salts. However, under these conditions there is not enough potassium to substitute into each phosphorous acid molecule. Such formulations necessarily have free acid and hence a lower pH value when diluted 200-2000-fold for use. Such formulations can be useful, e.g., when water supplies used for dilution are innately basic in pH, which is often the case. Theoretical precision is achieved by those skilled in the art, who know the practical applications of the Henderson-Hasselbalch equation (pH=pK+log [dissociated acid]/[associated acid]) and the polyprotic nature of phosphoric and phosphorous acid. See Martin et al. (1985) Harper's Review of Biochemistry, 20^{th} Ed., pp. 9-13 and the Handbook of Chemistry and Physics, 57^{th} ed., 1CRC press, 1976. For example, phosphoric acid has three acid groups, each capable of dissociation at a different pH. pK1˜2.12, pK2˜7.21, and pK3˜12.67 (25C). Phosphorous acid, by contrast, has only two acid groups, with respective pKs of 2.00 and 6.59 (18C). The pK is defined as that pH at which the protonated and unprotonated species are present a equal concentrations. Martin et al. (1985) Harper's Review of Biochemistry, 20^{th} Ed., pp. 9-13. Using such equations and constants, one can appropriately manipulate the pH of a fertilizer.

Reciprocal scenarios are also envisioned. For example, reacting greater than 3 moles of potassium hydroxide per mole of phosphorous or phosphoric acid will result in phosphorous-containing compounds that are saturated with potassium, and which contain excessive, free potassium and hydroxide ions in solution. After standard dehydration or drying, the solid stock of such a formulation will likewise have a higher pH upon dilution.

### 4. Kits and Custom Formulations

For those interested in engaging in a fine manipulation of pH for a given application, in further aspects of the invention, suitably concentrated acid and base solutions are separately provided in a kit format along with the fertilizer stock. Such solutions can be used to titrate and/or manipulate pH. An analogy is made to pH “dipsticks” and other colorimetric diagnostic reagent supplies found in the marketplace—such as chemical kits sold in connection with pool supplies. Items like these and suitable instructions for use are optionally contemplated for inclusion into such kits. These kits may find particular use where water supplies used for stock dilution vary widely in pH and/or salt content, and a set, controlled pH is desired maintained, or else the acidity or basicity of a given soil is desired to be enhanced, counteracted, or neutralized.

In still further aspects and embodiments contemplated for the invention, the stock solutions specified herein arc used in industrial or commercial hoppers which contain multiple and discreet chemical and chemical mixing reservoirs, wherein specific formulations can be inputted, i.e., electronically and/or mechanically induced to mix separate components in desired, custom formulations. Methods involving mixing and/or merging these formulations with other formulations or ingredients are therefore contemplated within the scope of the invention.

### 5. Anti-Microbial Applications

A particular anti-microbial aspect takes advantage of the known sensitivity of certain anaerobic soil microorganisms to gaseous molecular oxygen and/or hydrogen. By supplying potassium phosphite and phosphate stocks and stock dilutions thereof that generate such gases upon decomposition, plant pathogenic microorganisms sensitive thereto can be controlled, while a target plant is simultaneously or otherwise nutritionally benefited.

Because of the characteristic uptake of the formulations, especially, for example, the 0-59-39 formulation, the product may be formulated to introduce bactericides, fungicides, antivirals and antibiotics required by the plant.

For additional bactericidal properties, the source of potassium may be potassium nitrite. Such formulations have been found especially valuable, for example, to prevent and to treat Pierce disease. The preferred formulations may range, as for the potassium phosphite formulations described herein. Preferably, the potassium nitrite formulation is 0-59-39.

Pierce disease afflicts grapes, and other bacterial diseases that affect, for example, pears and other crops. Pierce disease is caused by a xylem-inhabiting bacteria, Xylella fastidiosa. The formulations of the present invention are useful to treat plants afflicted with Pierce disease and plants afflicted with other xylem-inhabiting bacteria such as almond leaf scorch, alfalfa dwarf, oleander leaf scorch, citrus variegated chlorosis, plum leaf scald, and coffee leaf scorch. It has been found that the formulations of the present invention have the ability to travel through the xylem where such bacteria is present. Preferably, for such treatment, the potassium nitrite formulation of 0-59-39 is used, and preferably, the pH is 1.5. Those of ordinary skill in the art can easily determine which other formulations of the invention, and pH, are useful, as well as other components, such as antibiotics, that may be added to treat such diseases.

One of skill in the art is capable of readily determining the precise microbicidal or pesticidal parameters for a given formulation and circumstance, e.g., by using a standard “jar test.”

### 6. Equipment for Storing, Measuring, and Administering Formulations

Another aspect of the invention is a retainer for housing and/or dispensing the fertilizer formulations described above. The retainer is optionally capable of containing multiple discreet fertilizer formulations simultaneously and may further comprise an optional means for performing at least one function selected from the group consisting of measuring, dispensing, mixing, cooling, and degassing said fertilizer formulation.

The retainer may further possess a second dispensing means for administration to crops or trees that is adapted for the particular crop administration to be performed, whether foliar, direct soil, injectional, irrigational, or aerial spray.

### EXAMPLES

### 1. Sample Calculation of a 0-59-39 Formulation

The formulation of a 0-59-39 fertilizer mix is a consequence of the following equation:
2KH₂PO₃⇄K₂O+P₂O₅+2H₂.

The molecular weights for the independent reagents may be determined from the atomic weights of the individual elements: K=39.102; H=1.008; P=30.974; O=15.9994. From this we determine that K₂O has a molecular weight of 93.9994 and P₂O₅ has a molecular weight of 141.945. The weight fraction that these individual components represent over their product, 2KH₂PO₃, is determined by dividing their respective weights by that of 2KH₂PO₃, or 240.1084. Doing so we obtain phosphorous content=141.945/240.1084 or 0.59117, and potassium content=93.9994/240.1084 or 0.39149. The P:K value therefore becomes approximately 59:39. Because no nitrogen is present, the solid formulation value is therefore 0-59-39 (note that if atomic number is used instead of atomic weight, we obtain a 0-58-38 formulation). The formulas are therefore approximate. The 2% that separates these components from 100% is molecular, gaseous hydrogen, which is liberated upon decomposition and which has the effect of aerating soil when the formulation is applied thereto.

The remaining formulations may be calculated in the same way and assume the general formulas depicted in FIG. 2.

### 2. General Preparation of a Stock

Appropriate amounts of phosphorous-containing acid(s), e.g., phosphorous acid, is/are combined with appropriate amounts of potassium hydroxide in water as described generally in examples 1-8 of U.S. Pat. No. 5,865,870, except that the resulting solution is then dehydrated or evaporated to yield the solid salt or mixture of solid salt and solid phosphorous-containing acid. Otherwise, methods may be used as generally described by Ebert et al (1964) Chem. Abst. 61 2529(d) and 12702(e), or by analogy to methods described in U.S. Pat. Nos. 4,119,724, 5,800,837, or 5,707,418.

Stock solutions of phosphorous-containing acids can be acquired by chemical manufacturers and distributors such as Aldrich (Milwaukee, Wis.). Preparation of phosphorous acid in particular may be prepared according to the methods of Dunhill (1990) Australasian Plant Pathology, Vol. 19, No. 4, pp. 138-139, or U.S. Pat. No. 5,800,837. Alternatively, pure phosphorous acid may be obtained commercially, e.g., from Aldrich and reacted or mixed with KOH to yield suitable salts.

As a point of reference, phosphorous acid has a molecular weight of 82 and phosphoric acid has a molecular weight of 98. Specific percent formulations including either or both of these potential ingredients can be prepared and adjusted accordingly. Other phosphorus-containing acids arc depicted in a nonexhaustive listing in FIG. 1. Species in that listing may also be reacted with potassium hydroxide to form suitable P:K salt formulations.

### 3. Use of a 0-59-39 Stock Perennial Trees and Vines

This formulation when properly diluted is suitable for most perennial trees and vines, e.g., apples, pears & other pome fruits; citrus, avocados, kiwi, olives, grape hops and other vine crops, plums, nectarines and other stone fruits, walnuts, almonds, pistachios and other nut crops, raspberries, blackberries and other caneberries.

Approximately one half ounce per tree is the recommended dosage, to be administered three times per year. This amount is dissolved appropriately 200-2000 fold in water.

### Annuals

Plant species such as tomatoes, peppers, strawberries, melons, cucumbers, potatoes, carrots, onions and other tuber crops, broccoli, cauliflowers, beans, peas, corn and other leafy crops such as lettuce, celery, endives, parsley and others require approximately 1.5 to 3 pounds per acre, dissolved appropriately in water. The first application should be administered at the second leaf stage, with two subsequent applications to be applied at two week intervals.

### Aerial Application

For aerial application, add approximately 4 to 16 ounces of 0-59-39 mix per 20 gallons of water. Follow quantity requirements for annuals or perennials specified above.

### Soil Application

To a large premeasured water-containing dispenser tank add approximately one-half ounce of solid formulation to 100-1000 parts water times the number of trees to be fertilized. Preferably, application is repeated three times per year: once in the spring, once in the summer, and prior to the onset of cold weather.

As a soil application to annual crops, a lesser response from the initial crop may be seen versus succeeding crops. Placement close to seed or root zones may be injurious to crops, and may be aggravated by a soil pH below 6.5.

### Foliar Application

Add 3 pounds of formulation to 100 gallons of water. To help increase fruit set in the spring, 10 lbs. of low biuret urea may be added. Best results are achieved when applied three times per year: spring, summer and prior to the onset of cold weather.

### Compatibility with Pesticides and Micronutrients

Appropriate dilutions of the stock are compatible with most commonly used pesticides and micronutrients. For pesticides, a “jar test” as known in the art should be performed prior to any trial run. Those of skill in the art know how to determine and execute pesticide and micronutrient addition.

### Stock Storage

It is recommended that the fertilizer stocks described herein be stored in a cool, dry location. Containers should be tightly closed.

### 4. Use of a 1-59-39 Solid Formulation to Treat and Prevent Pierce Disease

Directions for improved Grape hops and other vine crops

Generally, it is recommended to use 1.5 to 3 lbs of 1-59-39 per acre as an in-line drip per application, with initial application at bud break.

For Table Grapes: It is recommended to make first application at bloom. Apply subsequent applications at bunch pre-closing, and two to three weeks prior to harvest.

For Wine Grapes: Make first applications at 5% bloom. Make subsequent applications at bunch pre-closing, and two to three weeks prior to harvest.

AS PREVENTATIVE METHOD:

Apply 0-59-39 at the rate of one to three pounds per acre per month in drip system during May-August.

### 5. Use of a 035-27 Formulation Perennial Trees and Vines

This formulation when properly diluted is suitable for most perennial trees and vines, e.g., apples, pears & other pome fruits; citrus, avocados, kiwi, olives, grape hops and other vine crops, plums, nectarines and other stone fruits, walnuts, almonds, pistachios and other nut crops, raspberries, blackberries and other caneberries.

Approximately one ounce per tree is the recommended dosage, to be administered three times per year. This amount is dissolved appropriately 200-2000 fold in water.

### Annuals

Plant species such as tomatoes, peppers, strawberries, melons, cucumbers, potatoes, carrots, onions and other tuber crops, broccoli, cauliflowers, beans, peas, corn and other leafy crops such as lettuce, celery, endives, parsley and others require approximately ¼-½ gallon per acre, dissolved appropriately in water. The first application should be administered at the second leaf stage, with two subsequent applications to be applied at two week intervals. Aerial, soil, and foliar administrations are otherwise performed as for Example 2 using appropriate adjustments.

### Field Application

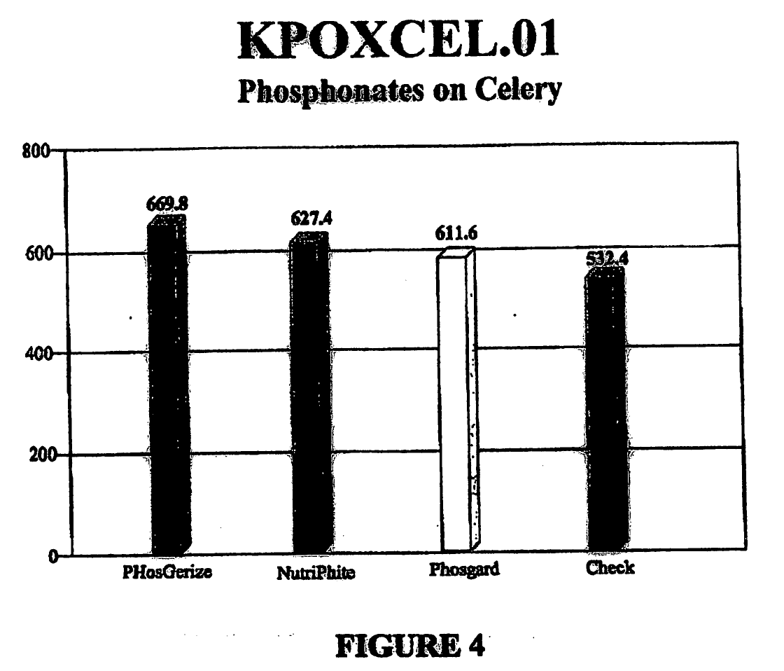

A 0-35-27 formulation was used in field trials on vegetables. The results of these field tests are presented below, and in Table 1 and in FIG. 4. Three lettuce, three bell pepper, two tomato, two celery, and one broccoli small plot were conducted and compared to standard growth practice (GSP) which varied for each vegetable. The number of treatments ranged from four to eight. All tests were based on replicated subsamples ranging from three to five replicates depending on the crop.

The formulation was applied with a solo hand-held sprayer to single bed plots from 50-75 feet in length. Application volume was generally around 50 gpa applied to pressures of 20-22 psi.

HEAD LETTUCE TESTS

WFS Test Code

| KPGNLET.01 | Gonzales, Ca | Rate Tested | = 2.0 qts/A | Number Treatments = 8 |
|---|---|---|---|---|
| | Applications: | 1^{st} 10/13 | 2^{nd} 10/22 | 3^{rd} 10/29 |
| | Harvest | 11/03 | | |
| | Head Wt (gms) | GSP | = 582.6 | |
| | | PhosGerize | = 669.2 | |
| KPKCLET.01 | King City, Ca | Rate Tested | = 2.0 qts/A | Number Treatments = 8 |
| | Applications: | 1^{st} 10/13 | 2^{nd} 10/22 | |
| | Harvest | 10/29 | | |
| | Head Wt (gms) | GSP | 588.8 | |
| | | PhosGerize | 686.6 | |
| ALIMKP.02 | Watsonville | Rate Tested | = 2.0 qts/A | Number Treatments = 4 |
| | Applications: | 1^{st} 08/20 | 2^{nd} 08/31 | |
| | Harvest: | 09/13 | | |
| | Head Wt (gms) | GSP | 555.4 | |
| | | PhosGerize | 862.6 | |
| | Cut/Plot | GSP | 52.4 | |
| | | PhosGerize | 161.5 | |

WFS Test Code

BELL PEPPERS

| KPGILPE.01b | Gilroy, Ca | Rate Tested | = 1.5 qts/A | Number Treatments = 7 |
|---|---|---|---|---|
| | Applications: | 1^{st} 06/07 | 2^{nd} 06/24 | |
| | Harvest: | 07/15 | | |
| | # Frt/Plant | GSP | = 6.8 | |
| | | PhosGerize | = 6.8 | |
| | Ttl. Wt (gms) | GSP | = 6817 | |
| | | PhosGerize | = 9339 | |
| KPGILPE.02b | Gilroy, Ca | Rate Tested | = 1.5 qts/A | Number Treatments = 7 |
| | Applications: | 1^{st} 06/24 | 2^{nd} 07/12 | |
| | Harvest (1): | 07/27 | | |
| | # Frt/Trt | GSP | = 25 | |
| | | PhosGerize | = 26 | |
| | Frt Wt/Trt (gms) | GSP | = 5425 | |
| | | PhosGerize | = 6864 | |
| | Harvest (2) | 08/09 | | |
| | # Frt/Trt | GSP | = 17 | |
| | | PhosGerize | = 19 | |
| | Frt Wt/Trt (gms) | GSP | = 2242 | |
| | | PhosGerize | = 3439 | |
| KPOXPEP.01 | Oxnard, Ca | Rate Tested | = 2.0 qts/A | Number Treatments = 6 |
| | Applications: | 1^{st} 06/03 | 2^{nd} 06/23 | |
| | Harvest (1): | 07/14 | | |
| | # Frt/Trt: | GSP | = 13 | |
| | | PhosGerize | = 15 | |
| | Frt Wt/Trt (gms) | GSP | = 1666.7 | |
| | | PhosGerize | = 2839.5 | |
| | Harvest (2) | 08/09 | | |
| | # Frt/Trt | GSP | = 44 | |
| | | PhosGerize | = 52 | |
| | Frt Wt/Trt (gms) | GSP | = 7876.0 | |
| | | PhosGerize | = 9500.8 | |

TOMATOES

| | | | | |
|---|---|---|---|---|
| KPGILTO.01b | Gilroy, Ca | Rate Tested | = 1.5 qts/A | Number Treatments = 7 |
| | Applications: | 1^{st} 06/25 | 2^{nd} 07/12 | |
| | Harvest: | 08/26 | | |
| | # Frt/Rep | GSP | = 275 | |
| | | PhosGerize | = 397 | |
| | Frt Wt/Rep(kg) | GSP | = 22.3 | |
| | | PhosGerize | = 39.8 | |
| KPHOTO.02 | Hollister, Ca | Rate Tested | = 2.0 qts/A | Number Treatments = 7 |
| | Applications: | 1^{st} 07/08 | 2^{nd} 07/19 | |
| | Harvest: | 09/22 | | |
| | # Frt/Trt | GSP | = 674 | |
| | | PhosGerize | = 1113 | |
| | Frt Wt/Trt(kg) | GSP | = 55.8 | |
| | | PhosGerize | = 107.7 | |

WFS Test Code

CELERY

| | | | | |
|---|---|---|---|---|
| KPOXCEL.01 | Oxnard, Ca | Rate Tested | = 2.0 qts/A | Number Treatments = 8 |
| | Applications: | 1^{st} 10/07 | 2^{nd} 10/18 | 3^{rd} 10/26 |
| | | 4^{th} 11/05 | 5^{th} 11/15 | 6^{th} 12/03 |
| | Harvest: | 12/20 | | |
| | StkWt (gms) | GSP | = 562.4 | |
| | | PhosGerize | = 669.8 | |
| KPSMCEL.02 | Santa Maria | Rate Tested | = 2.0 qts/A | Number Treatments = 7 |
| | Applications: | 1^{st} 07/29 | 2^{nd} 08/12 | |
| | Harvest: | 09/23 | | |
| | StkWt (gms) | GSP | = 862 | |
| | | PhosGerize | = 918 | |

BROCCOLI

| | | | | |
|---|---|---|---|---|
| KPWVBRO.02 | Moss Landing | Rate Tested | = 2.0 qts | Number Treatments = 7 |
| | Applications: | 1^{st} 05/11 | 2^{nd} 06/01 | |
| | Harvest | 06/21 | | |
| | Flr Wt (gm) | GSP | = 214.0 | |
| | | PhosGerize | = 235.3 | |

The data is presented in tabular form below.

TABLE 1
Phosgerize (0-35-27) Trial Data

| | | Rate | No. | App. Days | | Fresh Weights¹ | | % of |
|---|---|---|---|---|---|---|---|---|
| Crop | Location | qt/ac | Apps | b harv | Units | Control | Phosgerize | control |
| Head Lettuce | Gonzales | 2 | 3 | 21, 12, 5 | g | 583 | 669 | 115% |
| Head Lettuce | King City | 2 | 2 | 16, 7 | g | 589 | 687 | 117% |
| Head Lettuce | Watsonville | 2 | 2 | 25, 14 | g | 555 | 863 | 155% |
| | Head Lettuce | | | | | | | |
| | Average | | | | | 576 | 739 | 129% |
| Bell Peppers | Gilroy | 1.5 | 2 | 39, 22 | g | 6,817 | 9,339 | 137% |
| Bell Peppers | Gilroy | 1.5 | 2 | 33, 15 | g | 7,667 | 10,303 | 134% |
| Bell Peppers | Oxnard | 2 | 2 | 41, 21 | g | 9,543 | 12,341 | 129% |
| | Bell Peppers | | | | | | | |
| | Average | | | | | 8,009 | 10,661 | 134% |
| Tomatoes | Gilroy | 1.5 | 2 | 62, 45 | kg | 22 | 40 | 178% |
| Tomatoes | Hollister | 2 | 2 | 77, 66 | kg | 56 | 108 | 193% |
| | Tomatoes | | | | | | | |
| | Average | | | | | 39 | 74 | 186% |
| Celery | Oxnard | 2 | 6 | 74, 63, 55, | g | 562 | 670 | 132% |
| | | | | 45, 35, 17 | | | | |
| Celery | Santa Maria | 2 | 2 | 57, 43 | g | 862 | 918 | 106% |
| | Celery Average | | | | | 737 | 794 | 108% |
| Broccoli | Moss Landing | 2 | 2 | 42, 20 | g | 214 | 235 | 110% |

¹Harvested area not indicated so cannot calculate yield/acre or return/acre.

FIG. 4 shows the results, in bar graph form, for celery treatment. The 0-35-27 formulation (PhosGerize™) resulted in greater celery size yield than other commercially available fertilizers NutriPhite™ (0:29:26) and Phosgard™ (0:28:25).

### 6. Use of a 1-35-27 Liquid Formulation to Treat and Prevent Pierce Disease

Directions for improved Grape hops and other vine crops

Generally, it is recommended to use 2 to 4 pints of 1-35-27 as an in-line drip per acre per application, with initial application at bud break.

For Table Grapes: It is recommended to make application at bloom. Apply subsequent applications at bunch pre-closing, and two to three weeks prior to harvest.

For Wine Grapes: Make applications at 5% bloom. Make subsequent applications at bunch pre-closing, and two to three weeks prior to harvest.

AS PREVENTATIVE METHOD:

Apply 0-35-27 at the rate of one gallon per acre per month in drip system during May-August.

### 7. Use of a 0-85-0 Stock

This is supplied in flake form as a straight fertilizer of concentrated phosphorous acid. It has general properties as described in Example 2 two except that it possesses and contributes no or minimal potassium.

### Mature Fruit Trees and Vines

This formulation when properly diluted is suitable for most perennial trees and vines, e.g., apples, pears & other pome fruits; citrus, avocados, kiwi, olives, grape hops and other vine crops, plums, nectarines and other stone fruits, walnuts, almonds, pistachios and other nut crops, raspberries, blackberries and other caneberries.

Approximately 1.5 ounces per tree per year is recommended. This amount is dissolved appropriately in water.

### Annuals

Plant species such as tomatoes, peppers, strawberries, melons, cucumbers, potatoes, carrots, onions and other tuber crops, broccoli, cauliflowers, beans, peas, corn and other leafy crops such as lettuce, celery, endives, parsley and others require approximately 1-3 pounds per acre, dissolved appropriately in water. The first application should be administered at the second leaf stage, with two subsequent applications to be applied at two week intervals.

### Soil Application

Place in a water dispenser tank or acid resistant mechanical injector a suitable dilution. Typically, a mature tree will required approximately 1.5 ounces per year, administered in a total of three administrations . This is best added at the end of the irrigation cycle and otherwise per recommendations noted in example 2.

### Foliar Application

Add 3-6 pounds of formulation to 100 gallons of water. Add potash (KOH) sparingly until pH of about 6-7 is obtained. To help increase fruit set in the spring, 10 lbs. of low biuret urea may be added. Best results are achieved when applied three times per year: spring, summer and prior to the onset of cold weather.

This solution will leach out any micronutrient sprayed on leaves. Therefore, it is recommended to avoid any micronutrient such as zinc spray on the leaves when using this formulation. This is intended to be used as a supplemental fertilizer treatment.

### Compatibility

Due to the corrosive nature of this acid, appropriate care should be exercised to not mix it with strong basic solutions such as dormant oil, lime sulfur, or spray lime. Also, avoid contact with metals such as brass, iron, or copper. Stainless steel or acid resistant plastic is recommended.

### 8. Use of a 0-0-80 Stock

This is a concentrated potassium hydroxide solution and should be appropriately handled. Mature perennial trees & vines requires about 2.25 ounces per tree per year. Annuals require 1.5-3.0 lbs. per acre. A final pH of about 6.5 is best.

### 9. Use of a 0-040 Stock

This too is a concentrated potassium hydroxide solution and should be appropriately handled. Mature perennial trees & vines requires about 4.5 ounces per tree per year. Annuals require ¼-½ gallon per acre. The first application is preferably made at the second leaf stage, with two subsequent applications within two weeks intervals. A final pH of about 6.5 is best.

### 10. Mixes

Mixtures of the above fertilizers can be conveniently made and applied/distributed accordingly.

All references cited herein are hereby incorporated by reference, although none is admitted to be prior art. Moreover, the discussion and examples given are illustrative only and are not meant to limit or detract from the true scope and spirit of the invention. The same is true of the claims, below.

1. A fertilizer formulation comprising between approximately 45-85% phosphorous by weight and approximately 15-45% potassium by weight.

2. The fertilizer formulation of claim 1 wherein the potassium is in the form of one of the compounds selected from the group consisting of monopotassium phosphate, monopotassium phosphite and monopotassium nitrite.

3. The fertilizer formulation of claim 1 wherein the potassium is in the form of a mixture of monopotassium nitrite and monopotassium phosphate.

4. The fertilizer formulation of claim 1 wherein the potassium is in the form of a mixture of monopotassium phosphate, monopotassium phosphite and monopotassium nitrite.

5. The fertilizer formulation of claim 1 wherein the formulation is a time-release formulation.

6. The fertilizer formulation of claim 1 comprising approximately 59-85% phosphorous by weight and 15-39% potassium by weight.

7. The fertilizer formulation of claim 1 comprising approximately 55-59% phosphorous by weight and approximately 33-39% potassium by weight.

8. The fertilizer formulation of claim 1 further comprising at least one component selected from the group consisting of bactericides, fungicides, antivirals and antibiotics.

9. The fertilizer formulation of claim 1 wherein the fertilizer formulation may be used as an alternate to methyl bromide fumigate.

10. The fertilizer formulation of claim 1 wherein the formulation is unbuffered.

11. An aqueous dilution of the fertilizer formulation of claim 1.

12. The aqueous dilution of claim 11 wherein the dilution is in the range of 200 to 2000 fold.

13. A method of producing the fertilizer formulation of claim 1 comprising reacting a phosphorous-containing acid and potassium nitrite.

14. A method of delivering a fertilizer formulation to a plant with enhanced beneficial effect, said method comprising:
adding to the soil individual reactants necessary to produce the fertilizer formulation of claim 1, said reactants capable of reacting beneath the soil and evolving gases that inhibit pathogenic fungal and bacterial growth and thereby both delivering essential nutrients to said plant and thwarting pathogenic microorganism growth that is detrimental to the plant.

15. The method of claim 14 wherein the reactants are selected from the group consisting of phosphoric acid, phosphorous acid and KOH.

16. A method of fertilizing plants comprising administering the formulation of claim 1 in an in-line drip irrigation system.

17. A method of treating a plant afflicted with a xylem-inhabiting bacterial disease comprising administering the formulation of claim 1.

18. The method of claim 17 comprising administering said formulation by injection.

19. A method of treating a plant afflicted with one of the diseases selected from the group consisting of pythium, fusarium, cylindrocladium, erwinia and phytophora comprising administering to the plant the fertilizer formulation of claim 1.

20. The fertilizer formulation of claim 3 wherein the fertilizer formulation maybe used as an alternate to methyl bromide fumigate.
